(19) United States
(12) Patent Application Publication
(10) Pub. No.: US 2006/0274609 A1
(43) Pub. Date: Dec. 7, 2006

(54) Silent alarm wrist watch

(76) Inventors: Glenn E. Lindsey SR., Chicago, IL (US); Glenn E. Lindsey JR., Chicago, IL (US)

Correspondence Address: GLENN E. LINDSEY SR., 9120 SO KEELER AVE, OAKLAWN, IL, 60453, US

(21) Appl. No.: 11/027,611

(22) Filed: Jun. 6, 2005

(51) Int. Cl. G04B 19/06

(52) U.S. Cl. 368/230

(57) ABSTRACT

The Silent Alarm Wristwatch is a simple, but innovative look at the alarm clock. The Silent Alarm Wristwatch uses another sense oppose to the bedside hearing systems. The Silent Alarm Wristwatch is digital alarm that vibrates instead of ringing or music and awakes specific individuals oppose to the entire household or roommate. Its' features include vibrating three times in three second intervals after the set time, possesses a snooze button and three alternate vibrations low, medium and high for moderate to heavy sleepers. The Silent Alarm Wristwatch is a comfortable timepiece made of terry cloth with a Velcro fastener for comfort and the alarm is made of a lightweight plastic. The Silent Alarm Wristwatch will be more effective and personal and is the answer to the consumer who cannot wake up from conventional alarm clocks.

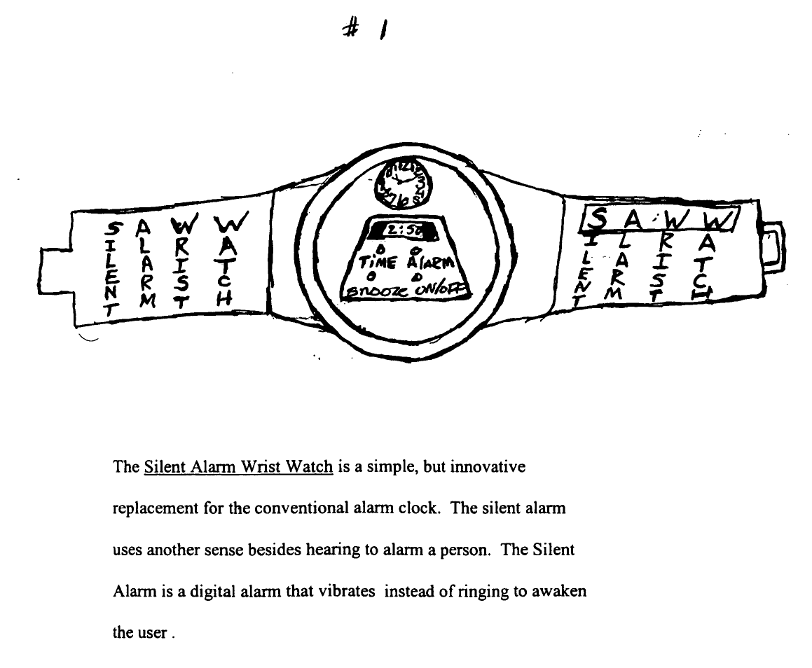

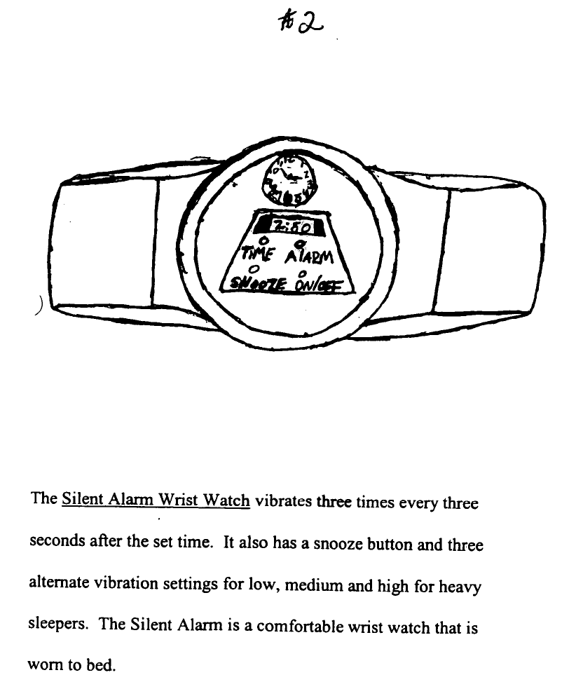

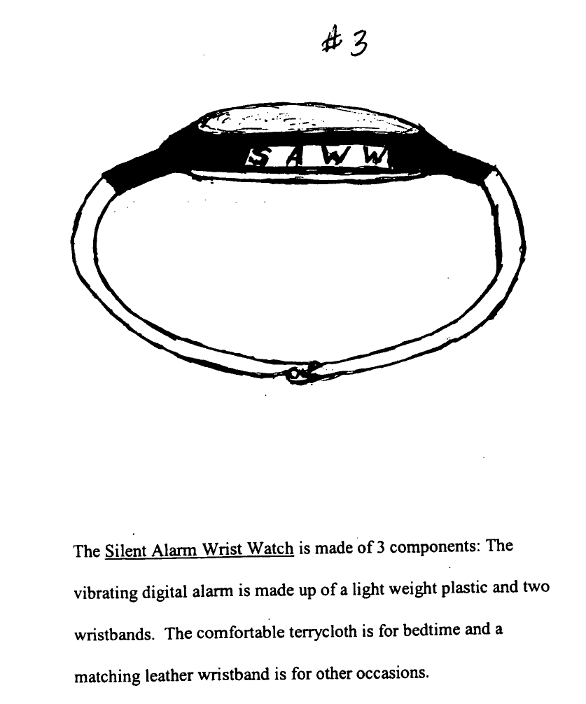

In this fast-paced new millennium, dual-working parent households and swing-shift schedules are common. Stay-at-home moms are a remnant of the past for most families. In addition, the old 9 to 5 schedule orthodoxy has been eaten away in many companies by the dual pressures of global competition and flexible workplace hours. As a result, when one member of a couple wakes up in the morning, the spouse is likely to gain an hour or more of precious sleep. In families with babies interfering with parents' sleep, this is even more likely. However, the alarm clock set by the first spouse generally shatters the efforts of the second to sleep.

The “SILENT ALARM WRIST WATCH” would solve this problem. The “SILENT ALARM WRIST WATCH” would provide a way for a person to waken on time while allowing his or her spouse or partner to sleep. Because the alarm would consist of vibration on the wrist of the person who needed to awaken first, the second person would continue to sleep peacefully. This could contribution to family harmony and reduces stress - - - major accomplishments in these high-pressured times.

### BACKGROUND OF THE INVENTION

The “Silent Alarm Wristwatch” would consist of a disc-shaped watchcase with a top face including two sections - - - a round analog top and a trapezoidal digital bottom. The round top would look like the traditional analog watch with numbers around the edge and a minute hand and hour hand in the middle. The trapezoidal bottom would include a liquid crystal display (LCD) on top and the following buttons underneath: TIME, ALARM, SNOOZE and ON/OFF. The vibrations would be settable to three different levels - - - low, medium, and high.

Printed on the side of the watchcase would be SAWW (acronym for SILENT ALARM WRIST WATCH). There would be half a wristband attached to each side of the watchcase. Each wristband half would have half a clasp on the end. The two clasp pieces would be fastened together to secure the “SILENT ALARM WRIST WATCH” on the user's wrist. “SILENT ALARM WRIST WATCH” would be printed on each half-wristband, with each word appearing as a vertical column of letters. There would be two wristbands included with the “SILENT ALARM WRIST WATCH”, a leather one for during the day and a terry cloth one for wearing to bed at night.

1. The Silent Alarm Wrist Watch is a simple, but innovative replacement for the conventional alarm clock. The silent alarm uses another sense besides hearing to alarm a person. The Silent Alarm is a digital alarm that vibrates instead of ringing to awaken the user.

2. The Silent Alarm Wrist Watch vibrates three times every three seconds after the set time. It also has a snooze button and three alternate vibration settings for low, medium and high for heavy sleepers. The Silent Alarm is a comfortable wrist watch that is worn to bed.

3. The Silent Alarm Wrist Watch is made of 3 components: The vibrating digital alarm is made up of a light weight plastic and two wristbands. The comfortable terrycloth is for bedtime and a matching leather wristband is for other occasions.

4. The Silent Alarm Wrist Watch can be worn as an alarm clock and a reminder. Because of the silence it can be worn anywhere. The wrist attachment makes the Silent Alarm more effective than the conventional alarm clock and will certainly help those people that simply can not hear alarms during their sleep.
